(19) United States
(12) Patent Application Publication
(10) Pub. No.: US 2021/0069533 A1
(43) Pub. Date: Mar. 11, 2021

(54) SAFETY HARNESS

(71) Applicant: Chris Hodges, Lakeland, FL (US)

(72) Inventor: Chris Hodges, Lakeland, FL (US)

(21) Appl. No.: 16/409,771

(22) Filed: May 10, 2019

(51) Int. Cl. A62B 35/00

(52) U.S. Cl. CPC A62B 35/0037

(57) ABSTRACT

A safety harness system is described. In some examples, a safety harness system can include a safety harness and a belt securing the safety harness. The safety harness system can also include a first double ring connector and a second double ring connector attached to the belt. The first double ring connector can be constructed with a first bend to fit on a first side of the belt and the second double ring connector can be constructed with a second bend to fit on a second side of the belt opposite to the first side of the belt. Also, the first double ring connector and the second double ring connector can each be configured with at least two connection points.

### FIELD

Some implementations relate generally to safety harness systems, and more particularly, to a safety harness with a double ring.

### BACKGROUND

Some existing safety harnesses may be commonly used by linemen working on utility poles. For example, linemen may be required by safety standards or company policy to keep at least one safety strap/line attached to the safety harness belt around a utility pole at all times. When a lineman encounters an obstruction while working on a pole, the lineman may be required to unhook the safety strap/line from a connector on the safety harness belt and cross over the obstruction. During this maneuver, the lineman may need to keep another (e.g., a backup) safety strap/line attached to the safety harness belt as a backup to prevent the lineman from falling.

Commonly used safety harness belts may have either two D-rings or four D-rings. Attaching two different safety straps/lines to the same D-ring when using a safety harness belt with only two D-rings can be a difficult proposition. A safety harness belt with four D-rings may have the additional two D-rings attached to separate locations on the safety harness belt vis-à-vis the first two D-rings. Such an arrangement may not be comfortable to a lineman as the backup safety strap/line can pull from a different location on the safety harness belt when a lineman switches to the backup or second safety strap/line upon encountering an obstruction on the pole.

It may be desirable to provide a new and improved safety harness that keeps both safety straps/lines near the same location by attaching them to the same location. This arrangement can ensure that the safety straps/lines pull from the same position on the safety harness belt when a lineman or a user of the safety harness switches to the backup safety strap/line from the primary safety strap/line. Some implementations were conceived in light of the above-mentioned limitations, needs, or problems, among other things.

The background description provided herein is for the purpose of generally presenting the context of the disclosure. Work of the presently named inventors, to the extent it is described in this background section, as well as aspects of the description that may not otherwise qualify as prior art at the time of filing are neither expressly nor impliedly admitted as prior art against the present disclosure.

### SUMMARY

Some implementations include a safety harness system. The safety harness system can include a safety harness and a belt securing the safety harness. The safety harness system can also include a first double ring connector and a second double ring connector attached to the belt, wherein the first double ring connector and the second double ring connector can each be configured with at least two connection points. The first double ring connector can be constructed with a first bend to fit on a first side of the belt and the second double ring connector can be constructed with a second bend to fit on a second side of the belt opposite to the first side of the belt.

The first double ring connector can be configured with a first connection point located near a first bend and a second connection point located away from the first bend. The second double ring connector can be configured with a first connection point located near a first bend and a second connection point located away from the first bend.

The first double ring connector and second double ring connector can each comprise a mechanism to attach to the belt. The mechanism can include one or more of fasteners, slots, hooks, or magnets. The first double ring connector and second double ring connector can each be made of one or more of plastic, metal, stone, textile, natural, synthetic, or composite material.

A safety line and backup safety line can be attached to two of the at least two connection points of each of the first double ring connector and the second double ring connector. The two connection points can include a first connection point on the first double ring connector and a second connection point on the second double ring connector. Each safety line/strap can be connected to the first connection point and the second connection point described above.

A method of securing a safety harness can include attaching a first safety line to a first connection point of a double ring connector, attaching a second safety line to a second connection point of the double ring connector, removing the first safety line upon encountering an obstacle, and reinstating the first safety line after crossing over the obstacle. The double ring connector can be constructed with a bend to fit on a side of a belt for securing the safety harness. The double ring connector can be configured with a first connection point located near a bend and a second connection point located away from the bend. The double ring connector can include a mechanism to attach to a belt for securing the safety harness. The mechanism can include one or more of fasteners, slots, hooks, or magnets. The double ring connector can be made of one or more of plastic, metal, stone, textile, natural, synthetic, or composite material.

In some implementations, a safety harness system can include a safety harness and a belt securing the safety harness. The safety harness system can also include a first double ring connector attached to the belt, wherein the first double ring connector can be configured with a first connection point and a second connection point, and a second double ring connector attached to the belt, wherein the second double ring connector can be configured with a third connection point and a fourth connection point. The safety harness system can also include a safety line attached to the first connection point and the third connection point and a backup safety line attached to the second connection point and the fourth connection point.

The first double ring connector can be constructed with a first bend to fit on a first side of the belt and the second double ring connector can be constructed with a second bend to fit on a second side of the belt opposite to the first side of the belt. The first double ring connector can be configured with a first connection point located near a first bend and a second connection point located away from the first bend. The second double ring connector can be configured with a first connection point located near a first bend and a second connection point located away from the first bend. The first double ring connector and the second double ring connector each can include a mechanism to attach to the belt. The mechanism can include one or more of fasteners, slots, hooks, or magnets. The first double ring connector and the second double ring connector can each be made of one or more of plastic, metal, stone, textile, natural, synthetic, or composite material.

### BRIEF DESCRIPTION OF THE DRAWINGS

FIG. 1 is a diagram showing a side view of an example safety harness in accordance with some implementations.

FIG. 2A is a diagram showing a front view of an example double ring connector configured for use on a left side of a safety harness in accordance with some implementations.

FIG. 2B is a diagram showing a front view of an example double ring connector configured for use on a right side of a safety harness in accordance with some implementations.

FIG. 3A is a diagram showing a top view of an example double ring connector configured for use on a left side of a safety harness in accordance with some implementations.

FIG. 3B is a diagram showing a top view of an example double ring connector configured for use on a right side of a safety harness in accordance with some implementations.

FIG. 4 is a diagram showing a front and top perspective view of an example double ring connector configured for use on a right side of a safety harness in accordance with some implementations.

### DETAILED DESCRIPTION

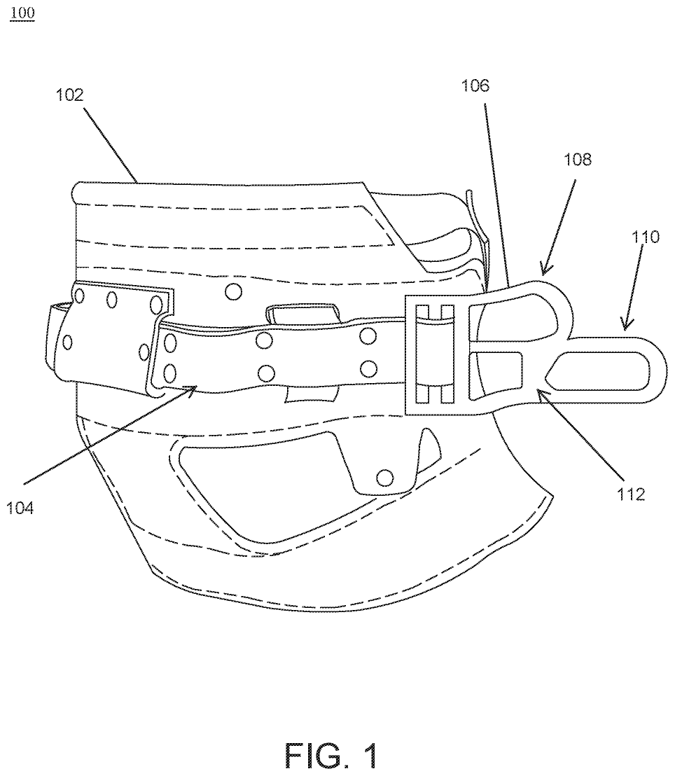

FIGS. 1-4 show diagrams of an example safety harness system (e.g., 100) and/or components thereof. Such example safety harness systems can, for example, be used by linemen working in the utility industries (e.g., in the electrical and telecommunications fields). In FIG. 1, an example safety harness system 100 can include a safety harness 102, a belt 104 securing the safety harness, and a first double ring connector 106 for use on the right side of the belt and to which a safety line can be connected. The first double ring connector 106 can be constructed with a first bend 112 to fit on a first (e.g., a right) side of the belt. Also, the first double ring connector 106 can include a first connection point 108 and a second connection point 110.

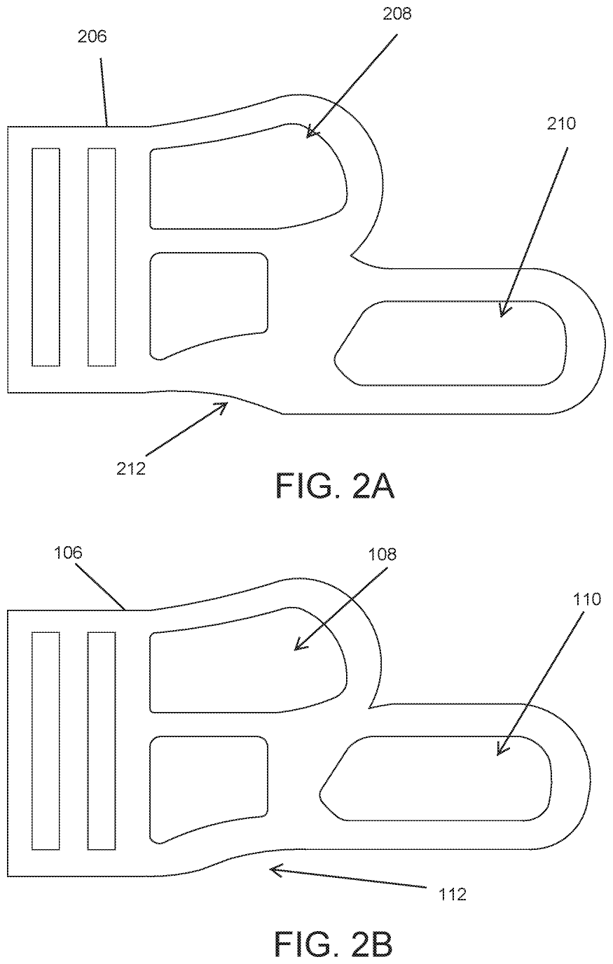

FIG. 2A and FIG. 2B show diagrams of front views of example double ring connectors in accordance with some implementations. FIG. 2A shows a front view of an example first double ring connector configured for use on a left side of a safety harness in accordance with some implementations. FIG. 2B shows a front view of an example second double ring connector configured for use on a right side of a safety harness in accordance with some implementations.

The example first double ring connector 106 in FIG. 2A can be constructed with a first bend 112 configured to fit on a first side (e.g., right side) of the belt. The first double ring connector 106 can include a first connection point 108 located near the first bend 112 and a second connection point 110 located away from the first bend 112. The example second double ring connector 206 in FIG. 2B can be constructed with a second bend 212 configured to fit on a second side (e.g., left side) of the belt. The second double ring connector 206 can include a first connection point 208 located near the second bend 212 and a second connection point 210 located away from the second bend 212. While described herein as left or right side for illustration purposes, it will be appreciated that the double ring connectors can be placed on either side of a belt (e.g., the first side can be right or left, and the second side can be the opposite side from the first side).

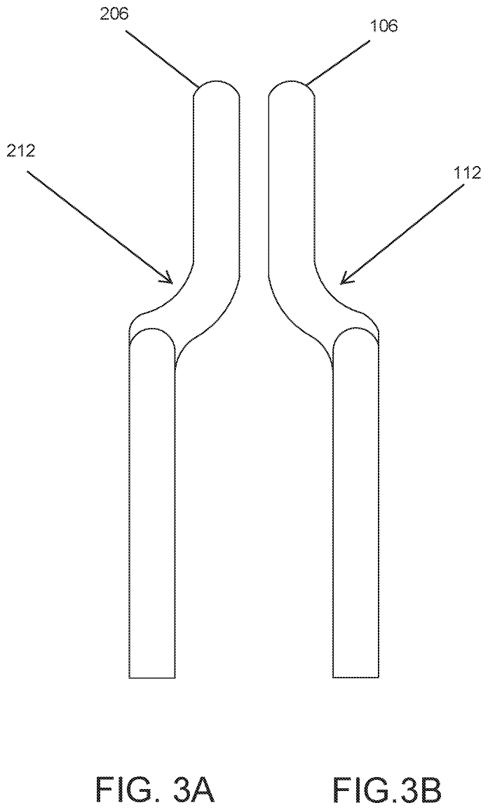

FIG. 3A and FIG. 3B show diagrams of top views of example double ring connectors in accordance with some implementations. FIG. 3A shows a top view of the second double ring connector 206 constructed with a second bend 212 and configured to fit on a second side (e.g., left side) of a belt for use on the second side (left side) of a safety harness in accordance with some implementations. FIG. 3B shows a top view of the first double ring connector 106 that is constructed with a first bend 112 and configured to fit on a first side (e.g., right side) of the belt for use on the first side (right side) of safety harness in accordance with some implementations. The first double ring connector 106 and the second double ring connector 206 each can include a mechanism to attach to the belt. The mechanism can include one or more of fasteners, slots, hooks, or magnets.

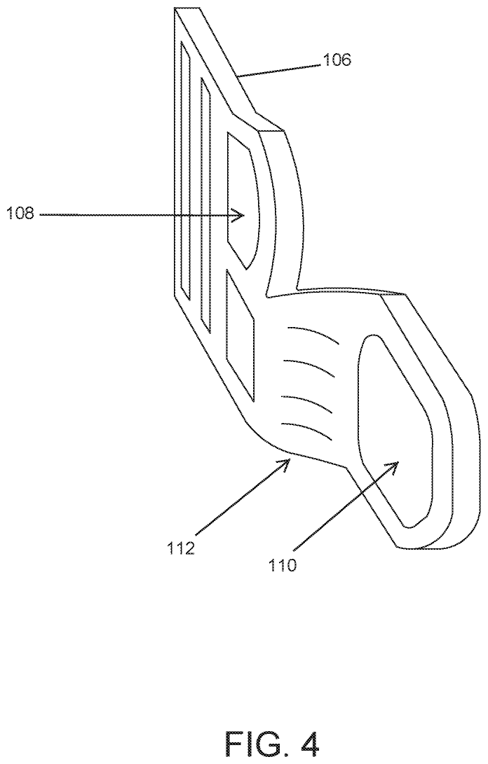

FIG. 4 shows a diagram of a front and top perspective view of an example double ring connector in accordance with some implementations. The first double ring connector 106 can be constructed with a first bend 112 to fit on a first (e.g., right) side of a belt and the double ring connector 106 can include a first connection point 108 and a second connection point 110.

The safety harness can be a safety harness used by, for example, linemen of utility companies in some implementations. It will be appreciated that the safety harness and safety harness belts described herein are for illustration purposes only and not intended to be limiting. Other types/kinds of safety harnesses and/or safety harness belts may be used depending on a contemplated implementation. It will also be appreciated that the double ring connector(s) described herein is for illustration purposes only and is not intended to be limiting. Other types of double ring connectors can be used depending on a contemplated implementation. For example, the first double ring connector and the second double ring connector can be made of one or more of plastic, metal, stone, textile, natural, synthetic, or composite material.

In some implementations, a safety harness system can include a safety harness and a belt securing the safety harness. The safety harness system can also include a first double ring connector attached to the belt, wherein the first double ring connector can be configured with a first connection point and a second connection point, and a second double ring connector attached to the belt, wherein the second double ring connector can be configured with a third connection point and a fourth connection point. The safety harness system can also include a safety line attached to the first connection point and the third connection point and a backup safety line attached to the second connection point and the fourth connection point.

In operation, a user of a safety harness may attach a primary safety strap/line to the first connection points 108 and 208 on the first double ring connector 106 and the second double ring connector 206 respectively. The user of the safety harness may attach a backup safety strap/line to the second connection points 110 and 210 on the first double ring connector 106 and second double ring connector 206 respectively. The double ring (D-ring) connector combines two D-rings into a single connector so that the primary and backup safety straps/lines can be attached to the same location and pulled from the same position when hooked to the harness. In other implementations, the double ring connectors above can have more than two connection points.

A method of securing a safety harness can include attaching a first safety line to a first connection point of a double ring connector, attaching a second safety line to a second connection point of the double ring connector, removing the first safety line upon encountering an obstacle, and reinstating the first safety line after crossing over the obstacle. The double ring connector can be constructed with a bend to fit on a side of a belt for securing the safety harness. The double ring connector can be configured with a first connection point located near a bend and a second connection point located away from the bend. The double ring connector can include a mechanism to attach to a belt for securing the safety harness. The mechanism can include one or more of fasteners, slots, hooks, or magnets. The double ring connector can be made of one or more of plastic, metal, stone, textile, natural, synthetic, or composite material.

It will be appreciated that any dimensions described herein are for illustration purposes only and are not intended to be limiting. Other dimensions could be used depending on a contemplated implementation.

It is therefore apparent that there is provided, in accordance with the various example implementations disclosed herein, a safety harness system with a double ring connector.

While the disclosed subject matter has been described in conjunction with a number of implementations, it is evident that many alternatives, modifications and variations would be or are apparent to those of ordinary skill in the applicable arts. Accordingly, Applicant intends to embrace all such alternatives, modifications, equivalents and variations that are within the spirit and scope of the disclosed subject matter.

What is claimed is:

1. A safety harness system comprising:
a safety harness;
a belt securing the safety harness; and
a first double ring connector and a second double ring connector attached to the belt, wherein the first double ring connector and the second double ring connector are each configured with at least two connection points.

2. The safety harness system of claim 1, wherein the first double ring connector is constructed with a first bend to fit on a first side of the belt and the second double ring connector is constructed with a second bend to fit on a second side of the belt opposite to the first side of the belt.

3. The safety harness system of claim 1, wherein the first double ring connector is configured with a first connection point located near a first bend and a second connection point located away from the first bend.

4. The safety harness system of claim 1, wherein the second double ring connector is configured with a first connection point located near a first bend and a second connection point located away from the first bend.

5. The safety harness system of claim 1, wherein the first double ring connector and the second double ring connector each comprise a mechanism to attach to the belt.

6. The safety harness system of claim 5, wherein the mechanism includes one or more of fasteners, slots, hooks, or magnets.

7. The safety harness system of claim 1, wherein the first double ring connector and the second double ring connector are each made of one or more of plastic, metal, stone, textile, natural, synthetic, or composite material.

8. The safety harness system of claim 1, wherein a safety line and a back up safety line are attached to two of the at least two connection points of each of the first double ring connector and the second double ring connector.

9. A method of securing a safety harness, the method comprising:
attaching a first safety line to a first connection point of a double ring connector;
attaching a second safety line to a second connection point of the double ring connector;
removing the first safety line upon encountering an obstacle; and
reinstating the first safety line after crossing over the obstacle.

10. The method of claim 9, wherein the double ring connector is constructed with a bend to fit on a side of a belt for securing the safety harness.

11. The method of claim 9, wherein the double ring connector is configured with a first connection point located near a bend and a second connection point located away from the bend.

12. The method of claim 9, wherein the double ring connector comprises a mechanism to attach to a belt for securing the safety harness.

13. The method of claim 12, wherein the mechanism includes one or more of fasteners, slots, hooks, or magnets.

14. The method of claim 9, wherein the double ring connector is made of one or more of plastic, metal, stone, textile, natural, synthetic, or composite material.

15. A safety harness system comprising:
a safety harness;
a belt securing the safety harness;
a first double ring connector attached to the belt, wherein the first double ring connector is configured with a first connection point and a second connection point;
a second double ring connector attached to the belt, wherein the second double ring connector is configured with a third connection point and a fourth connection point;
a safety line attached to the first connection point and the third connection point; and
a backup safety line attached to the second connection point and the fourth connection point.

16. The safety harness system of claim 15, wherein the first double ring connector is constructed with a first bend to fit on a first side of the belt and the second double ring connector is constructed with a second bend to fit on a second side of the belt opposite to the first side of the belt.

17. The safety harness system of claim 15, wherein the first double ring connector is configured with a first connection point located near a first bend and a second connection point located away from the first bend.

18. The safety harness system of claim 15, wherein the second double ring connector is configured with a first connection point located near a first bend and a second connection point located away from the first bend.

19. The safety harness system of claim 15, wherein the first double ring connector and the second double ring connector each comprise a mechanism to attach to the belt.

20. The safety harness system of claim 15, wherein the first double ring connector and the second double ring connector are each made of one or more of plastic, metal, stone, textile, natural, synthetic, or composite material.
